(19) United States
(12) Patent Application Publication
(10) Pub. No.: US 2009/0193946 A1
(43) Pub. Date: Aug. 6, 2009

(54) DIRECT BLADE DRIVE

(76) Inventors: Frank A. Bondarowicz, Park Ridge, IL (US); Scott J. Rote, New Lenoy, IL (US); Scott M. Zeeb, Chicago, IL (US)

Correspondence Address: THOMPSON HINE LLP;Intellectual Property Group, P.O Box 8801, DAYTON, OH, 45401-8801, US

(21) Appl. No.: 12/299,148

(22) PCT Filed: Apr. 26, 2007
(86) PCT No.: PCT/US07/09967

§ 371 Date: Mar. 9, 2009

Related U.S. Application Data
(60) Provisional application No. 60/796,782, filed on May 2, 2006.

(51) Int. Cl. B26D 1/00; B26D 5/08

(52) U.S. Cl. 83/13; 83/571

(57) ABSTRACT

A food-slicer includes a motor, a motor shaft rotatably connected to the motor, and a blade mounted directly to an end portion of the motor shaft.

### RELATED APPLICATIONS

This application claims the benefit of U.S. Provisional Patent Application 60/796,782, filed May 2, 2006, the entirety of which is incorporated herein by reference.

### BACKGROUND OF THE INVENTION

The present invention relates to food slicers.

Food products often come in undesired sizes, particularly meats and cheeses. These bulk products are then sliced, using slicers, into more desirable sizes. For example, delicatessen meats and cheeses often come in sizes not conducive to consumption by a family within a time. These large portions are then individually sliced for retail consumption.

While a simple knife and fork are able to perform the slicing, the task is made easier and more accurate with rotary slicing devices that rotate a blade to slice the food. The food is translated horizontally and vertically relative to the rotating blade to slice. Typically, the food is held in a position on a product table.

Some slicers are configured to rotate at different speeds to obtain preferred rotation speeds based on the food to be sliced. For example, meat is optimally cut at a different rotation speed than cheese. Even more specifically, different meats and different cheeses cut better at different speeds.

The typical blade drive system includes a motor, a transmission, a spindle, and the blade. Generally, a fixed speed AC motor provides the power and a transmission provides the speed variance. Typical transmission devices may include belts and pulleys, gears, and chain and sprocket systems. Other systems include a multiple winding AC motor to obtain a fixed number of speeds. However, each of these solutions undesirably increases costs for the devices. Additionally, the multiple components required decrease reliability, require adjustment, and reduce efficiency due to mechanical losses between components. Furthermore, the system does not self correct blade speed, and requires larger packaging to accommodate the parts. What is needed is a slicer that can improve the prior art by reducing these disadvantages.

### SUMMARY OF THE INVENTION

The present invention provides a food-slicer includes a motor, a motor shaft rotatably connected to the motor, and a blade mounted directly to an end portion of the motor shaft.

Another aspect of the invention provides a method of slicing food. The method includes positioning a food product in a slicing position, energizing a motor, rotating a shaft including an end mounted blade responsive to the energized motor, and slicing the food based on the rotation.

Yet another aspect of the invention provides a system for slicing food. The system includes means for positioning a food product in a slicing position, means for energizing a motor, means for rotating a shaft at a first speed responsive to the energized motor, the shaft including an end mounted blade, and means for slicing the food based on the rotation.

These and other features and advantages of the present invention will be readily apparent from the following detailed description, in conjunction with the claims.

### BRIEF DESCRIPTION OF THE DRAWINGS

The benefits and advantages of the present invention will become more readily apparent to those of ordinary skill in the relevant art after reviewing the following detailed description and accompanying drawings, wherein:

FIG. 1 illustrates a bottom view of one embodiment of a food slicer, in accordance with one aspect of the invention;

FIG. 2 illustrates a side transparent view of the food slicer, in accordance with one aspect of the invention;

FIG. 3 illustrates a side cross sectional view of a motor, in accordance with one aspect of the invention;

FIGS. 4A and 4B illustrate a food slicer in accordance with one aspect of the invention; and

FIG. 5 illustrates a method of slicing food, in accordance with another aspect of the invention.

### DETAILED DESCRIPTION OF THE INVENTION

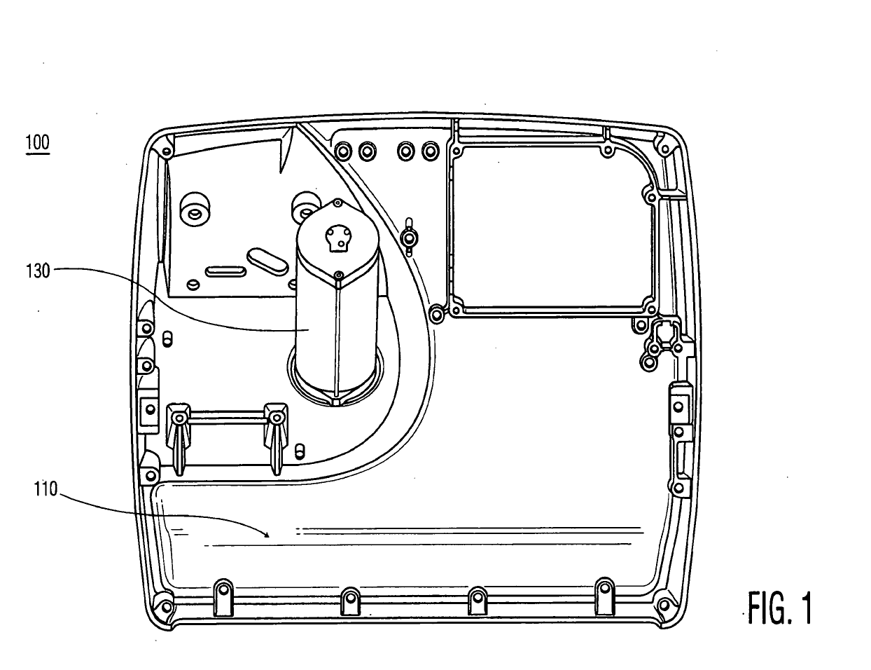

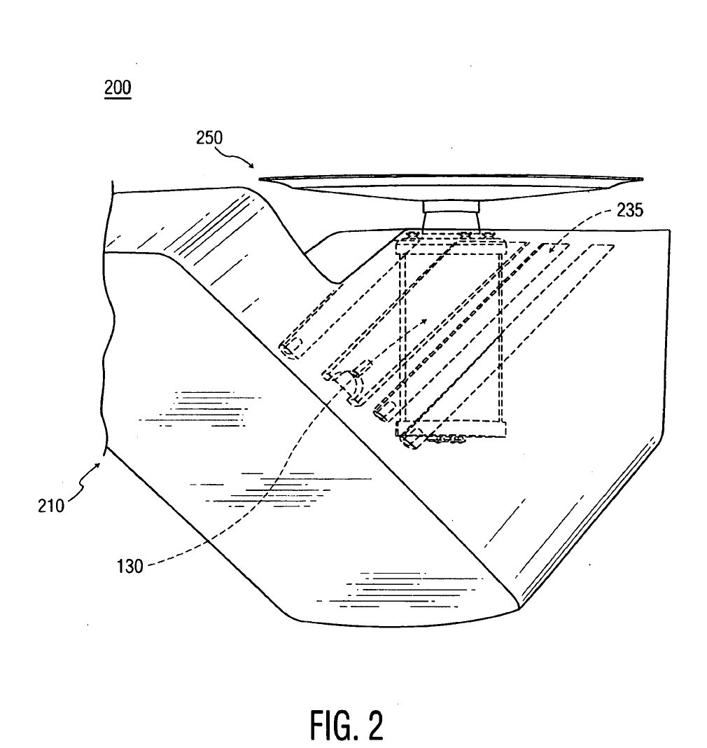

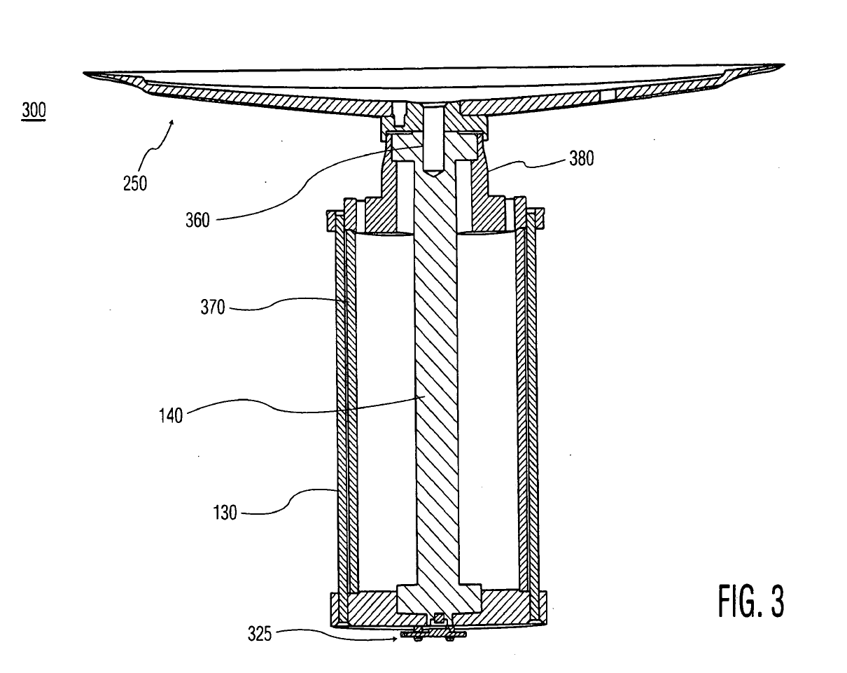

FIG. 1 illustrates a bottom view of one embodiment of a food slicer 100, in accordance with one aspect of the invention. Food slicer 100 includes a housing 110, and motor 130. In one embodiment, a product table is moveably attached to the housing 110. Motor 130 includes a motor shaft 140 (FIG. 3). Motor shaft 140 defines a motor shaft axis through a center point of the motor shaft. In one embodiment, motor 130 is a DC motor. In one embodiment, motor 130 is a brushless DC motor. Motor shaft 140 is rotatably connected to motor 130. A blade (250 in FIG. 2) is mounted directly to an end portion of the motor shaft. As shown in FIG. 1, the motor 130 is directly mounted to housing 110, although other mounting schemas are anticipated. In one embodiment, a portion of the motor shaft 140 is surrounded by the stator of motor 130, while a portion of the motor shaft 140 extends beyond the stator. In other embodiments, a portion of the motor shaft 140 is surrounded by a motor housing for motor 130, while a portion of the motor shaft 140 extends beyond the motor housing.

A product transport (not shown) positions a food product, such as meat or cheese, relative to a blade (FIGS. 2 and 3). In one embodiment, the product transport translates in a first direction substantially parallel to the motor shaft axis and configured to translate in a second direction substantially perpendicular to the motor shaft axis. In one embodiment, the translation in the first direction is at least partially gravity based as portions of the food product are cut away by the blade. In one embodiment, a retaining member provides additional mass to keep the food product resting on the product table. In such embodiments, the retaining member exerts a force on the food product, such as a force resulting from gravity.

FIG. 2 illustrates a side transparent view of the food slicer at 200, in accordance with one aspect of the invention. As shown in FIG. 2, the slicer includes a housing 210 and a motor 130. The motor 130 includes a motor shaft 140. Blade 250 is directly mounted to a first end of the motor shaft 140. In one embodiment, blade 250 is a substantially circular cutting edge configured to rotate about the motor shaft axis.

In one embodiment, blade 250 is threaded onto a threaded portion of motor shaft 140. In another embodiment, blade 250 is mounted onto motor shaft 140 using an appropriate fastener, such as a nut and bolt, screw, hex screw, or the like. In another embodiment, blade 250 is latched onto a portion of motor shaft 140.

FIG. 2 further illustrates motor mounting fasteners 235 coming from a surface just adjacent the blade 250 and extending through housing 210 and fastening to a nut member of motor 130. In one embodiment, the nut member is a brass insert. In one embodiment, the nut member is a tapped hole. In another embodiment, the nut member is disposed adjacent an inside surface of housing 210 and bosses on the motor are formed as through holes. In such embodiments, fewer openings are created in the exterior of the slicer, potentially reducing the clean up of the slicer post operation.

FIG. 3 illustrates a side cross sectional view of motor 130 with motor shaft 140 and blade 250, in accordance with one aspect of the invention. In one embodiment, the blade 250 includes a male mating portion 360 mated with female mating portion 370 of the motor shaft 140. In one embodiment, motor 130 is a brushless DC motor. Encoder 325 is disposed at a second end of motor shaft 140.

In one embodiment, the slicer includes a user interface. The user interface provides input devices to control the on/off of the slicer, as well as slicing speeds. In one embodiment, the user interface is in electronic communication with at least one electronic controller configured to control the rotation speed of the motor shaft 140 (FIG. 2), and thus blade 250. In one such embodiment, the controller establishes a desired motor shaft speed, such as from the user interface.

In one embodiment, the controller determines the actual rotation speed of the motor shaft 140. In one such example, the controller compares the actual rotation speed of the motor shaft 140 with a desired rotation speed, and if the actual rotation speed is less than the desired rotation speed, the controller increases the speed of the motor shaft 140 until the actual rotation speed is approximately the desired speed. In such embodiments, the controller self controls to ensure that the blade is actually rotating at the desired speed, and self-controls for any speed drop caused by the actual slicing of the food product. In one embodiment, the controller adjusts the motor shaft speed based on an auto-drive speed. In another embodiment, the controller adjusts the motor shaft speed based on a stroke setting received from the user interface.

In one embodiment, deflector 380 is mounted to one of the blade and motor shaft. Deflector 380 isolates the motor shaft from the ambient environment surrounding the blade to reduce infiltration of foreign matter, such as fluid or food slicing, from the motor. In one embodiment, deflector 380 is formed integral with the blade. In one embodiment, the deflector 380 is formed of a flexible material, such as rubber or other polymer, and operates as a seal.

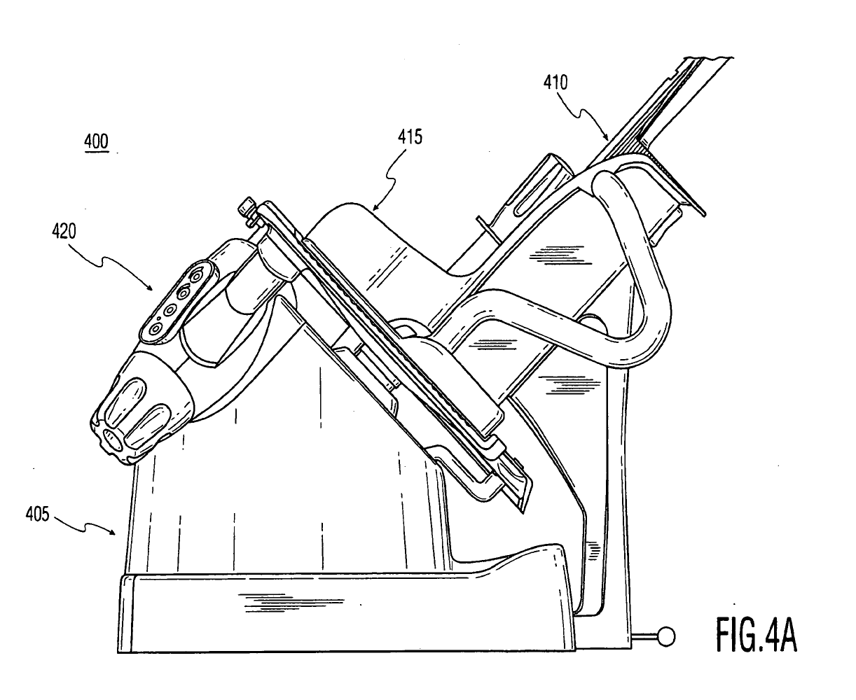

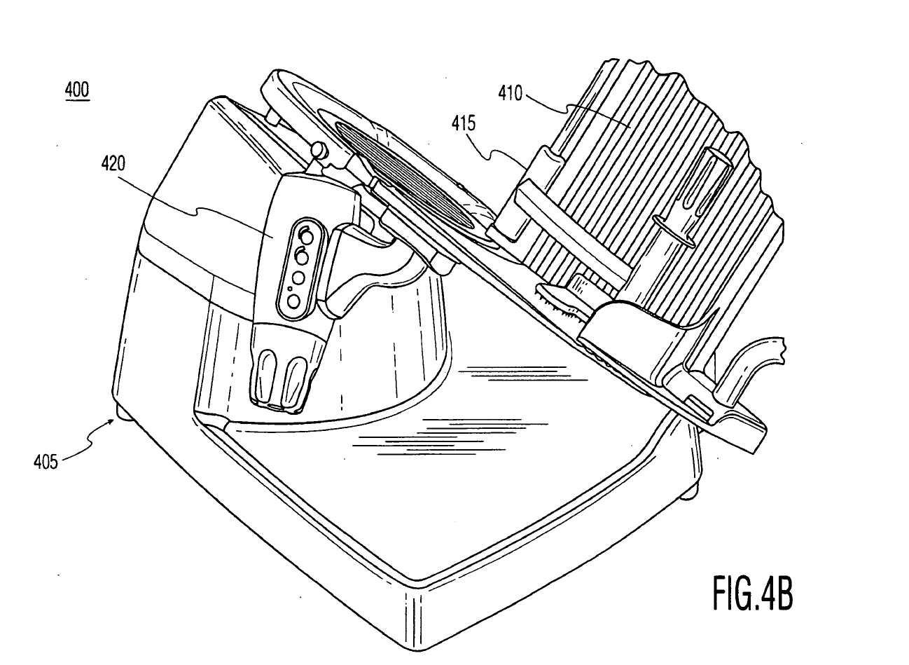

FIGS. 4A and 4B illustrate one embodiment of a food slicer 400 in accordance with another aspect of the invention. Food slicer 400 is illustrated in a side view in FIG. 4A, and in perspective view in FIG. 4B. Product table 410 is supported by housing 405. As illustrated, product table 410 is disposed at approximately 135 degrees from horizontal, although any appropriate angle can be used. A motor (not shown in FIGS. 4A, 4B) including a motor shaft with an end mounted blade is disposed near the product table 410. As shown in FIGS. 4A and 4B, product table 410 includes pusher 415. Pusher 415 holds a food product in position as the blade is slicing the food. In one embodiment, pusher 415 exerts a gravitational force downward against the food being sliced. In one embodiment, pusher 415 is operably connected to the product table.

Product table 410 is configured to translate along a product table path to move the food product into contact with, and away from, the blade. Product table 410 positions a food product, such as meat or cheese, relative to a blade (FIGS. 2 and 3). In one embodiment, the product transport translates in a first direction substantially parallel to the motor shaft axis and configured to translate in a second direction substantially perpendicular to the motor shaft axis. In one embodiment, the translation in the first direction is at least partially gravity based as portions of the food product are cut away by the blade. In one embodiment, a pusher provides additional mass to keep the food product resting on the product table. In such embodiments, the pusher exerts a force on the food product, such as a force resulting from gravity. In other embodiments, the pusher includes a biasing member, such as a spring, to exert mechanical forces on the food being sliced.

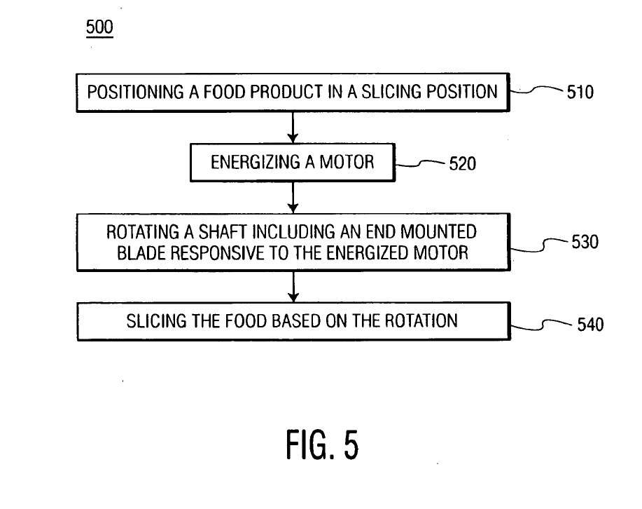

FIG. 5 illustrates one embodiment of a method of slicing food, in accordance with another aspect of the invention. Method 500 begins by positioning a food product in a slicing position during step 510. In one embodiment, the food product is placed on a product table. The motor, such as motor 130, is energized at step 520, and rotating a shaft including an end mounted blade responsive to the energized motor at step 530. The food product is sliced at step 530 based on the rotation.

Thus, using the disclosures herein, the reliability of a slicer can be improved by eliminating components, while simplifying assembly and maintenance. Mechanical loss of energy is reduced by reducing interaction with components, and with a smaller overall package size resulting from the omission of a transmission to set blade speed.

While the present invention is susceptible of embodiment in various forms, there is shown in the drawings and will hereinafter be described as presently preferred embodiments with the understanding that the presently preferred embodiments are to be considered an exemplification of the present invention and are not intended to limit the present invention to the specific embodiments illustrated.

It should be understood that the title of this section of this specification, namely, “Detailed Description of the Invention”, relates to a requirement of the United States Patent Office, and does not imply, nor should be inferred to limit the subject matter disclosed herein.

All patents referred to herein, are incorporated herein by reference, whether or not specifically done so within the text of this disclosure.

In the disclosure, the words “a” or “an” are to be taken to include both the singular and the plural. Conversely, any reference to plural items shall, where appropriate, include the singular.

From the foregoing it will be observed that numerous modification and variations can be effectuated without departing from the true spirit and scope of the novel concepts of the present invention. It is to be understood that no limitation with respect to the specific embodiments illustrated is intended or should be inferred. The disclosure is intended to cover by the appended claims all such modifications as fall within the scope of the claims.

1. A food-slicer comprising:
a motor;
a motor shaft directly driven by the motor; and
a blade mounted directly to an end portion of the motor shaft.

2. The food-slicer of claim 1 wherein the blade is a circular blade.

3. The food-slicer of claim 1 wherein the motor is a DC motor.

4. The food-slicer of claim 3 wherein the motor is a brushless DC motor.

5. The food-slicer of claim 1, wherein the motor comprises a stator, and wherein a portion of the motor shaft is surrounded by the stator, and wherein a portion of the motor shaft extends beyond the stator.

6. The food-slicer of claim 1 further comprising a motor housing surrounding the motor, and wherein a portion of the motor shaft is surrounded by the motor housing and wherein a portion of the motor shaft extends beyond the motor housing.

7. The food-slicer of claim 1 wherein the motor is mounted to a housing.

8. The food-slicer of claim 1 further comprising means for determining at least one speed drop.

9. The food-slicer of claim 8 further comprising means for controlling a rotation speed of the blade based on the determined speed drop.

10. The food-slicer of claim 1 further comprising a product table, the product table including a product transport configured to translate substantially perpendicular to an axis defined by the motor shaft and substantially parallel to the blade.

11. A method of slicing food, comprising:
positioning a food product in a slicing position;
energizing a motor;
rotating a motor shaft including an end mounted blade responsive to the energized motor; and
slicing the food based on the rotation.

12. The method of claim 11 wherein rotating the motor shaft comprises rotating the shaft at a first speed, and further comprising:
determining at least one speed drop responsive to slicing the food;
determining a speed change to counter the speed drop; and
rotating the motor shaft at a second speed responsive to the determined speed change.

13. The method of claim 11 wherein slicing the food comprises:
translating the food product in a first direction substantially parallel to a motor shaft axis; and
translating the food product in a second direction substantially perpendicular to the motor shaft axis.

14. A system for slicing food, comprising:
means for energizing a motor;
means for rotating a motor shaft at a first speed responsive to the energized motor, the motor shaft including an end mounted blade; and
means for slicing food based on the rotation.

15. The system of claim 14 further comprising:
means for determining at least one speed drop responsive to slicing the food;
means for determining a speed change to counter the speed drop; and
means for rotating the motor shaft at a second speed responsive to the determined speed change.

16. The system of claim 14 further comprising:
means for translating the food substantially perpendicular to an axis defined by the motor shaft and substantially parallel to the means for slicing food.
